(19) United States
(12) Patent Application Publication
(10) Pub. No.: US 2012/0209679 A1
(43) Pub. Date: Aug. 16, 2012

(54) SYSTEM AND METHOD FOR MANAGING REAL-TIME REWARDS PROGRAM

(75) Inventors: WENCESLAO CASARES, WOODSIDE, CA (US); MEYER MALKA, MENLO PARK, CA (US); FEDERICO MURRONE, BUENOS AIRES (AR)

(73) Assignee: Bling Nation, Ltd., Hamilton (BM)

(21) Appl. No.: 13/024,608

(22) Filed: Feb. 10, 2011

(51) Int. Cl. G06Q 30/00

(52) U.S. Cl. 705/14.17

(57) ABSTRACT

A system and method are provided that automatically track the use of an instrument used in a financial transaction to determine if any rewards or discounts should be applied. The system and method of the present invention apply the reward or discounts in real-time as part of the transaction authorization process.

### FIELD OF THE INVENTION

The present invention generally relates to electronic systems and, more specifically, to processing units that perform complex electronic transaction to provide real-time adjustments to transactions.

### BACKGROUND

Incentive programs provide users with incentives to shop at certain merchants participating in the programs. An incentive, also referred to as a reward, is something of value that can be redeemed. Incentives can vary from discounts on pricing to cash rewards. Additionally, incentives can be a general discount at a merchant or a specific discount on a specific product from a specific manufacturer. Yet another type of incentive can be free merchandise from a specific supplier or manufacturer or free merchandise from a retail seller.

Typically, users are awarded incentives when they spend money at merchants participating in or offering a particular incentive program or when they purchase a specific product that is affiliated with an incentive or reward program. Some incentive programs are cumulative and the consumer must spend a certain amount or buy a certain number of goods before receiving an incentive.

A typical consumer does not track spending related to an incentive program to know when an incentive has been awarded or available. Also, most consumers are not aware of the timing of when an incentive for a product is offered by a sponsor. Additionally, where multiple incentive offers exist for the same product, consumers have a difficult time tracking the source of the incentive or reward and this creates confusion for the consumer relating to how and what to redeem.

Additionally, a consumer that uses multiple financial instruments may not be able to redeem rewards as often, especially when rewards are tied to the actual instrument or credit card used in the transaction.

Therefore, what is needed is a system and method that automatically tracks the consumer's use of a financial transaction instrument (e.g., a credit or debit card) and is able to correlate the use of the instrument with an incentive program and applies the reward instantly.

### SUMMARY

A system and method are provided that automatically track the use of an instrument used in a financial transaction to determine if any rewards or discounts should be applied. The system and method of the present invention apply the reward or discounts in real-time as part of the transaction authorization process.

In accordance with one aspect of the present invention, a program administrator is used for ensuring that incentives are applied for each transaction as appropriate. Reference to the specification, including the drawings and claims, will realize other features and advantages of the present invention.

Further features and advantages of the present invention, as well as the structure and operation of various embodiments of the present invention, are described in detail below with respect to accompanying drawings, wherein like reference numbers indicate identical or functionally similar elements.

### DESCRIPTION OF THE DRAWING

FIG. 1 shows a system along with the data flow through the various parties involved in the overall financial transaction in accordance with the teachings of the present invention.

FIG. 2 is a block diagram representation of the data packets sent to a reward program processor and the data returned from the reward program processor.

FIG. 3 is a flow chart of the steps used by the reward program processor to determine if a reward should be applied to the present transaction shown in flow of FIG. 1.

### DETAILED DESCRIPTION

In general, incentive programs include a sponsor. One or more sponsors are providers of incentives, including rewards, discounts and coupons, for incentive programs. Sponsors are any entities, such as product manufacturers or a retail store, that can sponsor an incentive program. Sponsors define the rules or parameters of how an incentive program operates, including the rules that determine when an incentive is provided. This information may include the incentives that are awarded, the requirements that define if the incentive should be rewarded, the eligible participants, and the products or actions that will invoke an incentive when there is purchase, as well as actions that will result in a past incentive being revoked.

In order for incentives to be provided, a certain set of rules must be established and administered by a reward program administrator or processor for the sponsor. The reward program processor would receive information about the transaction and determine, based on the rules provided by the reward program sponsor, if there is a reward to be applied to the transaction in question. Given the fact that account information is involved, in accordance with one aspect of the present invention, unique data may be provided to the reward program processor instead of the actual account information. Thus, the reward program processor may apply a reward to the transaction in real time without having access to the account information.

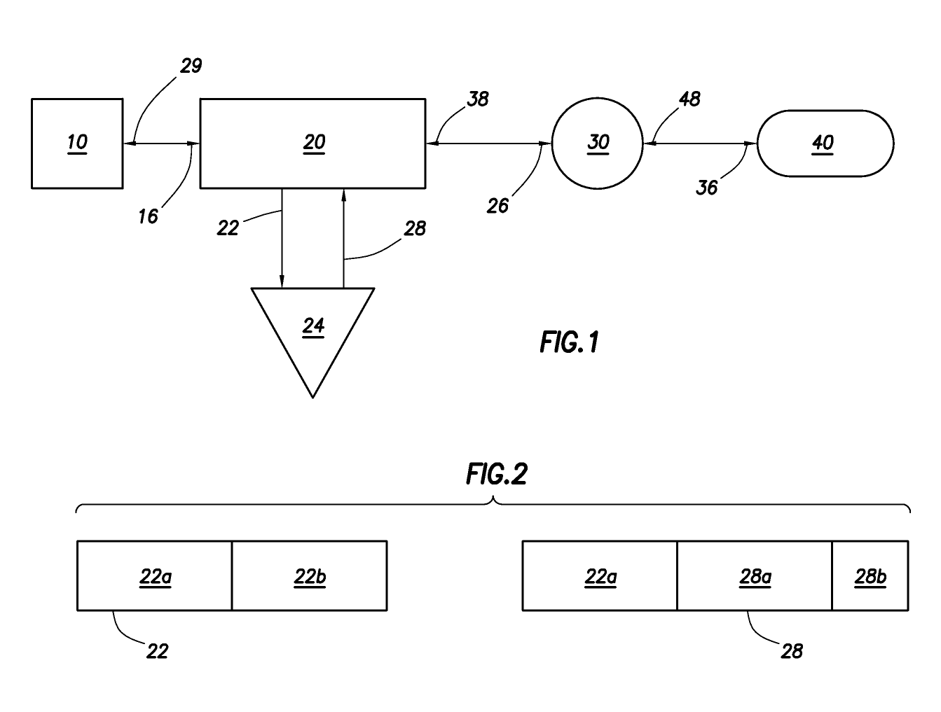

Referring to FIG. 1, a financial transaction is initiated at a point-of-sale device (POS) 10. The POS 10 may include a memory unit, a display, a magnetic reader, a processing unit, a communication unit for sending data to and receiving data from a third party involved in approval of the transaction, and a printing unit for printing information associated with the financial transaction. In accordance with various aspects of the present invention, the POS 10 may also include a short range wireless communication unit for reading information off of/from a contactless instrument, such as a contactless card or other near-filed communication (NFC) or RFID enabled device. The scope of the present invention is not limited by the components or features included as part of the POS used in capturing and sending the information associated with the financial transaction. The POS 10 captures the information associated with a card or a financial instrument, such as Track 1 and/or Track 2 data, and the transaction amount. As used herein, “Track 1” or “Track 2” data is the information stored on the magnetic strip located on the card as defined by the ISO/IEC 7811 and 7813 standards. Additional tracks may also be available on the card, such as a Track 3, even though not all POS devices will read or capture the information located from the additional track. The “Track” data includes, but not limited to, information such as, Primary Account Number (PAN) that varies from 15 to 19 characters, name of account holder, expiration date of the account, service code, discretionary data field that may be 1-5 characters, and other formatting related information or data. The minimum information needed to complete a transaction is present on each of Track 1 and Track 2, thereby allowing the POS device a secondary or backup track in case information on one track is corrupted or cannot read. to read one track if the information The information captured at the POS 10 may also include information associated with the specifics of the transaction. For example, the information may include additional details about the products purchased. In accordance with various aspects of the present information, there are additional data fields that may be used, which will depend on the type of transaction.

The POS 10 uses the information to generate a financial transaction approval request 16. In accordance with various aspects of the present invention, the approval request will include details about the amount of the transaction, the identity of the merchant, as well as the necessary information about the financial transaction instrument being used to complete the transaction. The scope of the present invention is not limited by the type of information that is included in the approval request 16. Once the approval request is formatted and prepared for transmission, the approval request 16 is sent from the POS 10 through a dedicated connection to an acquirer 20. The connection between the POS 10 and the acquirer 20 is a secure connection, wherein the information or data does not need to be sent encrypted and can be sent without encryption or in the clear. In accordance with another aspect of the present invention, the information in the form of the approval request 16 may be encrypted by the POS 10 and decrypted by the acquirer 20.

Referring now to FIG. 1 and FIG. 2, the acquirer 20 receives the information from the POS 10 and generates a reward request 22 that includes an identifying number (ID) 22a. The acquirer 20 includes a memory unit for storing information associated with the financial transaction and the identification information, such as ID 22a, associated with the user and/or the user account. The acquirer 20 includes a processing unit for analysis of the financial transaction in real-time in order to generate the ID 22a. The acquirer 20 also includes a communication unit for sending and receiving information in order to initiate and complete the financial transaction. The scope of the present invention is not limited by the exact type of devices or the additional functionality included as part of the acquirer 20.

The acquirer 20 derives or generates the ID 22a using a specific key and the account information associated with the financial instrument used in the financial transaction that is part of the approval request 16. In accordance with other aspects of the present invention, the key is known only by the acquirer so that only the acquirer can determine the specific account information from the ID 22a. In accordance with another aspect of the present invention, the key is shared with other trusted sources such as the reward program processor 24. Further in accordance with an aspect of the present invention, additional information may be used to derive the ID 22a, such as expiration date, account holder name, and any other data that is unique and constant so that the same ID 22a may be generated for future transaction events so that the reward program processor 24 is able to track the reward information associated with same financial account involved in future and past financial transactions. Thus, the ID 22a is used to uniquely represent the financial instrument that is to fund the transaction amount 22b.

Once the reward request 22 is sent to a reward program processor 24, the reward program processor 24 determines if there is a reward or an incentive that is applicable to the transaction. The reward program processor 24 includes a memory unit for storing information, a processing unit for comparing the transaction information with a set of program rules, and a communication unit for sending and receiving information. The reward program processor 24 includes various other components and devices. The scope of the present invention is not limited by the exact type of device or the additional functionality included as part of the reward program processor 24.

The reward program processor 24 compares the transaction in question to the set of reward program rules. If an applicable program rule is found, then the rule is applied. In accordance with one aspect of the present invention, the rule is applied to alter the transaction amount 22b. In some instances, application of the rule results in alteration of the transaction amount 22b because the required level of purchase amount or reward criteria was satisfied. In other instances, application of the rule will not result in alteration of the transaction amount 22b because the required level of purchase or the reward criteria was not satisfied. In the instant where application of the rule does not result in alteration of the transaction, application of the rule will result in an accumulation of a set number of points or credits that the reward program processor 24 tracks. Future transactions associated with the same ID 22a will be compared to the credits accumulated and the program rules to determine if additional credits should be accumulated or if the program rule has been satisfied in order to alter the transaction amount 22b.

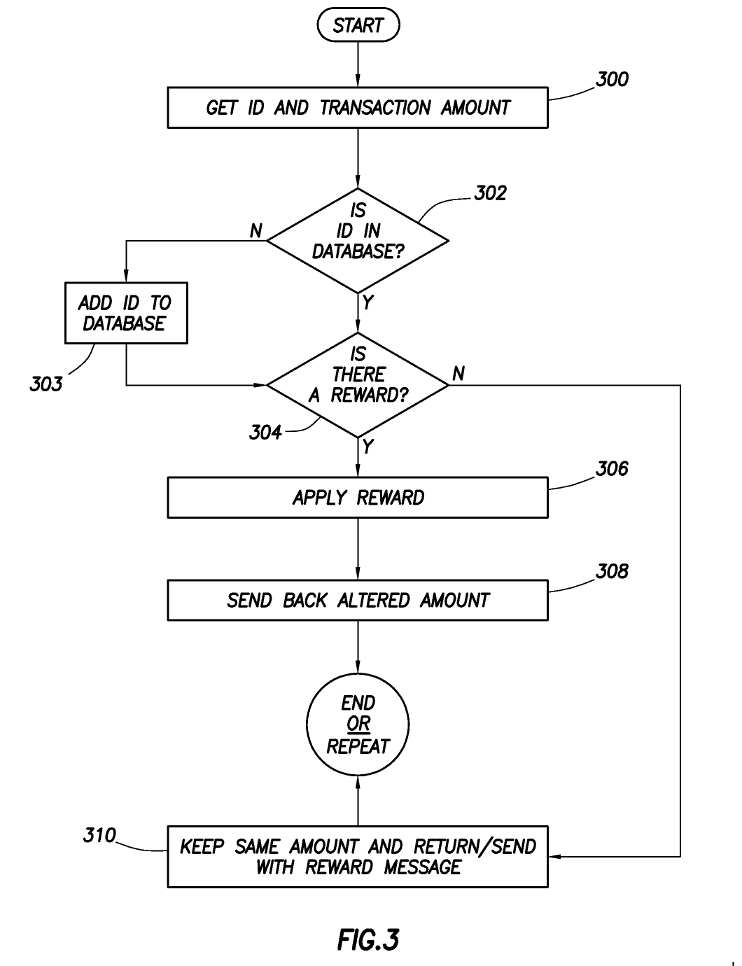

Referring now to FIG. 3, in order to compare past transaction and credits accumulated therefrom to future transactions, the reward program processor 24 maintains a database of ID types. At step 300, the program processor receives the ID 22a as part of the reward request 22. At step 302, each time an ID 22a is sent to the reward program processor 24, the reward program processor 24 determines if the ID 22a is already within the database or if the ID 22a needs to be added to the database. If the ID 22a needs to be added to the database, then at step 303 the ID 22a is added to the database or the memory unit where IDs are stored. At step 304, after the ID 22a exists within the database, then the reward program processor 24 determines the type and amount of the reward to be applied to the transaction, if any, as discussed above. At step 306, if there is a reward that is applicable to the transaction amount 22b for ID 22a and it results in an alteration of the transaction amount 22b, then the reward program processor 24 returns the user ID 22a, with some specific reward message or information 28a, and an altered transaction amount 28b as a reward response 28 to the acquirer 20 at step 308. In accordance with another aspect of the present invention, the reward program processor 24 returns the altered transaction amount 28b and stores the reward message 28a for later delivery to the acquirer 20, as discussed in detail below.

If at step 304 there is no reward to be applied, then at step 310 the reward program processor 24 does not alter the transaction amount 22b and returns a reward response 28 with the transaction amount 22b and the reward message 28a. The acquirer 20 uses the ID 22a to determine which approval request 16 is associated with the reward response 28. The acquirer 20 then alters the transaction amount 22b or leaves the transaction amount 22b the same and generates a formatted approval request 26 that is sent to the transaction processor 30. The processor 30 sends a forwarded request 36 to the financial institution 40 for approval.

The financial institution 40 sends an approved message 48, which is based on the transaction amount provided, to the processor 30. The processor 30 sends an approved transaction message 38 to the acquirer 20. The acquirer 20 produces a final approved message 29 that includes the reward message 28a. In accordance with one aspect of the present invention, the reward message 28a is stored by the reward program processor 24. Once the acquirer 20 receives the approved transaction message 38, the acquirer 20 requests the reward message 28a from the reward program processor 24. The acquirer 20 combines the reward message 28a with the approved transaction message 38 to produce the final approved message 29.

In accordance with another aspect of the present invention, the reward message 28a is stored at the acquirer 20. Once the approved transaction message 38 is received by the acquirer 20, the acquirer 20 can combine the reward message 28a with the approved transaction message 38 to produce the final approved message 29.

The acquirer 20 sends the final approved message 29 to the POS 10 to complete the transaction. The reward message 28a is extracted from the final approved message 29 and printed by the POS 10. The message printed includes, but is not limited to, any one or combination of the following information: the discount received; the amount of reward credits accumulated; the amount of reward credits needed to reach the next level of reward; and/or information about the program sponsor.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Certain ranges have been presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A system for providing a reward based on a transaction sent from an acquirer, the system comprising:
a memory unit that stores a set of reward program rules and participant identification information, wherein the reward program rules define the conditions for granting the reward;
a processing unit coupled to and in communication with the memory unit, wherein the processing unit compares a transaction amount value of the transaction to the reward program rules retrieved from the memory unit and wherein the processing unit determines if the transaction qualifies for the reward; and
a communication unit coupled to the processing unit and in communication therewith, the communication unit receives the transaction and the identification information from the acquirer and sends data associated with the transaction to the acquirer,
wherein the processing unit adjusts the transaction amount if the transaction qualifies for the reward and generates an adjusted transaction amount that the communication unit sends to the acquirer, and wherein the processing unit returns the transaction amount if the transaction does not qualify for the reward and updates credit data for the participant identification information that is associated with the transaction.

2. The system of claim 1, wherein the acquirer generates the participant identification information using a key and an account number that is being used to pay for the transaction.

3. The system of claim 2, wherein the credit data associated with the participant identification information accumulates and is stored in the memory unit until the reward program rules are satisfied and the participant identification information qualifies for the reward.

4. The system of claim 1, wherein the processing unit generates the participant identification information using a key and an account number that is being used to pay for the transaction.

5. A method for providing a reward and reward related information to a consumer conducting a transaction, the method comprising the steps of:
receiving a reward request that includes the transaction through a communication unit;
storing a set of program rules and participant identification in a memory unit of a computer system, wherein the program rules define the conditions for granting the reward;
retrieving the program rules using a processing unit in communication with the memory unit;
comparing a transaction amount value of the transaction to the program rules using the processing unit, wherein the transaction is received through the communication unit coupled to the processing unit;
determining if the transaction qualifies for the reward;
adjusting the transaction amount if the transaction qualifies for the reward to generate an adjusted transaction amount that the communication unit sends as a response to the reward request; and
returning the transaction amount as an alternative response to the reward request if the transaction does not qualify for the reward and updating credit data for the participant identification associated with the transaction.

6. The method of claim 5, further comprising the step of generating a reward message as part of the response.

7. The method of claim 6, further comprising the step of generating a reward credit message as part of the alternative response when the transaction does not qualify for the reward.
